(19) United States
(12) Patent Application Publication
(10) Pub. No.: US 2013/0006960 A1
(43) Pub. Date: Jan. 3, 2013

(54) Optimizing Database Queries

(75) Inventor: Pedro M. Barbas, Dunboyne (IE)

(73) Assignee: International Business Machines Corporation, Armonk, NY (US)

(21) Appl. No.: 13/172,094

(22) Filed: Jun. 29, 2011

(51) Int. Cl. G06F 17/30

(52) U.S. Cl. 707/713; 707/E17.017; 707/E17.122

(57) ABSTRACT

Some embodiments of the inventive subject matter include a method for transforming queries in a database management system. The can include detecting a first query, wherein the first query produces a first result upon evaluation by the database management system. The method can also include determining that the first query includes at least one operator, wherein the operator is selected from a union operator, an intersect operator, and an except operator, and wherein the operator has a first branch and second branch. The method can also include determining that the first branch of the operator accesses a first table, and wherein the second branch of the union operator also accesses the first table, and transforming the first query into a second query, wherein the second query does not include the operator, and wherein the second query produces the first result upon evaluation by the database management system.

### BACKGROUND

Embodiments of the inventive subject matter generally relate to the field of database management systems, and more particularly to tools for optimizing database queries.

Databases management systems (also referred to as database engines or simply DBMSs) often store very large volumes of data, such as employment records, computer logs, or other suitable information. DBMSs typically store this information for use by various software components, such as web servers, application programs, etc. Some DBMSs store information in tables organized in rows and columns. Some DBMSs support complex languages like SQL (Structured Query Language). A DBMS server may receive and process SQL queries that request data. In turn, the DBMS server performs operations defined in the queries, and returns data associated with the queries.

### SUMMARY

Some embodiments of the inventive subject matter include a method for transforming queries in a database management system. The can include detecting a first query, wherein the first query produces a first result upon evaluation by the database management system. The method can also include determining that the first query includes at least one operator, wherein the operator is selected from a union operator, an intersect operator, and an except operator, and wherein the operator has a first branch and second branch. The method can also include determining that the first branch of the operator accesses a first table, and wherein the second branch of the union operator also accesses the first table, and transforming the first query into a second query, wherein the second query does not include the operator, and wherein the second query produces the first result upon evaluation by the database management system.

Some embodiments of the inventive subject matter include a computer program product for transforming queries in a database management system. In some embodiments, the computer program product comprises a computer readable storage medium having computer usable program code embodied therewith. The computer usable program code comprising a computer usable program code configured to detect a first structured query language (SQL) query, wherein the first SQL query produces a first result. The program code can also determine that the first SQL query includes a union operator wherein the union operator includes a first branch and second branch, wherein the first and second branches are operands for the union operator. The program code can also determine that the first branch of the union operator accesses a first table, wherein the second branch of the union operator also accesses the first table. The program code can also transform the first SQL query into a second SQL query, wherein the second SQL query does not include the union operator, and wherein the second SQL query produces the first result.

### BRIEF DESCRIPTION OF THE DRAWINGS

The present embodiments may be better understood, and numerous objects, features, and advantages made apparent to those skilled in the art by referencing the accompanying drawings.

FIGS. 1A, 1B, and 1C depict database tables.

FIG. 2 is a block diagram illustrating a database management system, according to some embodiments of the inventive subject matter.

FIG. 3A shows database tables, according to some example embodiments discussed herein.

FIG. 3B shows the results of evaluating queries Q1 and Q2.

FIG. 4 shows data from a DBMS's optimizer after the optimizer processed query Q1.

FIG. 5 shows data from a DBMS's optimizer after the optimizer processed query Q2.

FIG. 6 shows the results produced by evaluating query Q4.

FIG. 7 shows how the optimizer processes Q4, and the access plan for processing Q4.

### DESCRIPTION OF EMBODIMENT(S)

### Introduction

The following description describes example systems, methods, techniques, instruction sequences and/or computer program products that embody techniques of the present inventive subject matter. However, the described embodiments may be practiced without these specific details. In some instances, for clarity, some well-known instruction instances, protocols, structures, and techniques may not be shown in detail.

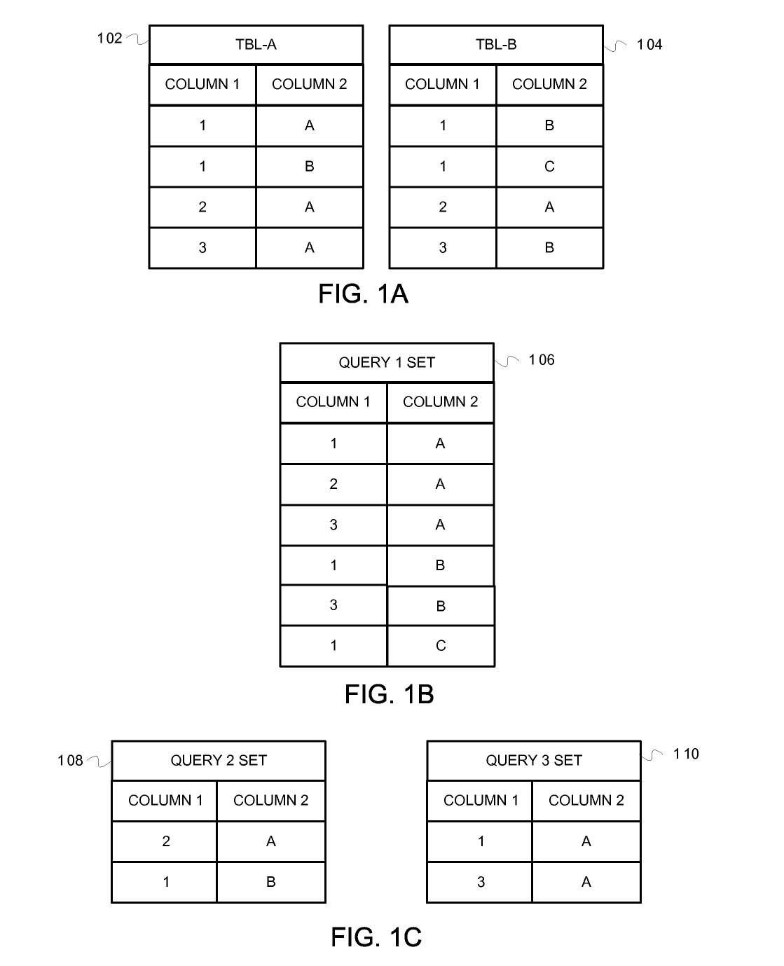

Many DBMSs support Union, Intersection, and Except queries. Union, Intersection, and Except queries are frequently used in database applications, such as in data warehouses that process very large sets of data. A Union query unconditionally merges two sets of input rows into a single output data set. The following describes an example of a Union query. For the purpose of illustration, assume that tables TBL-A (102) and TBL-B (104) contain the rows shown in FIG. 1A. Query1 is the following Union query that combines the rows of tables TBL-A and TBL-B.

### Query1:

select * from TBL-A union select * from TBL-B.
Given TBL-A and TBL-B (See FIG. 1A), Query1 produces a resulting set Query Set 1 (106), as shown in FIG. 1B.

Intersect queries merge two sets of input rows into a single output data set and retain only those rows that are common to both inputs. The following describes an example of an Intersect query that operates on tables TBL-A (102) and TBL-B (104).

### Query2:

select * from TBL-A intersect select * from TBL-B.
Given TBL-A and TBL-B (See FIG. 1A), Query2 produces a resulting set Query Set 2 (108), as shown in FIG. 1C.

Except queries merge two sets of input rows into a single output data set and retain only those rows that exist in the first data set, but not the second data set. The following describes an example of an Except query that operates on tables TBL-A (102) and TBL-B (104).

### Query3:

select * from TBL-A except select * from TBL-B.
Query3 produces the resulting set Query Set 3 (110), as shown in FIG. 1C.

In some DBMS, queries containing Union, Intersect, or Except statements cause the DBMS to run the query components on each branch of the Union, Intersect, or Except operator, and then combine the results. This can be costly in computing time. For example, if there are common tables on both branches of the Union, Intersect, or Except operator, many DBMSs will execute the Union, Intersect, or Except operation twice. Some embodiments of the inventive subject matter avoid such costly operations by rewriting queries to remove redundant operations, where such removals have no logical impact on the query results.

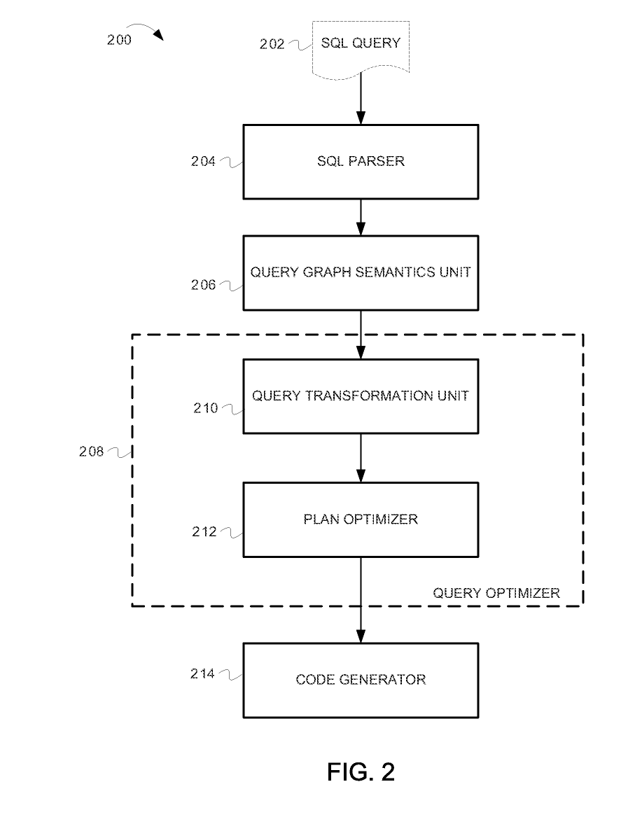

FIG. 2 is a block diagram illustrating components of a DBMS, according to some embodiments of the inventive subject matter. In FIG. 2, a DBMS 200 includes an SQL parser 204, query graph semantics unit 206, query optimizer 208, and code generator 214. FIG. 2 shows a SQL query 202 moving through the DBMS 200. The SQL query 202 passes to the SQL parser 204, which parses the query based on a grammar for the SQL language. After parsing the query 202, the query graph semantics unit 206 further processes the query 202 and/or data produced by the SQL parser 204.

The query optimizer 208 includes a query transformation unit 210 and a plan optimizer 212. The query optimizer's query transformation unit 210 transform queries, so they process faster, user fewer resources, etc. Embodiments of the query optimizer 208 transform queries that include Union, Intersect, and Except operators to be more efficient. The plan optimizer 212 optimizes access plans queries transformed by the query transformation unit 210. Ultimately, the DBMS's code generator 214 generates code for performing the query, where the code is executable by hardware on which the DBMS 200 operates.

### More Example Embodiments

Some embodiments of the inventive subject matter facilitate query optimization methods for SQL statements that include Union, Intersect, or Except operations. Some embodiments determine whether SQL statements include a common table on both branches of a Union, Intersect, or Except operation. If so, embodiments transform the query by eliminating one branch of the Union, Intersect, or Except operation, resulting in a more efficient query with the same results.

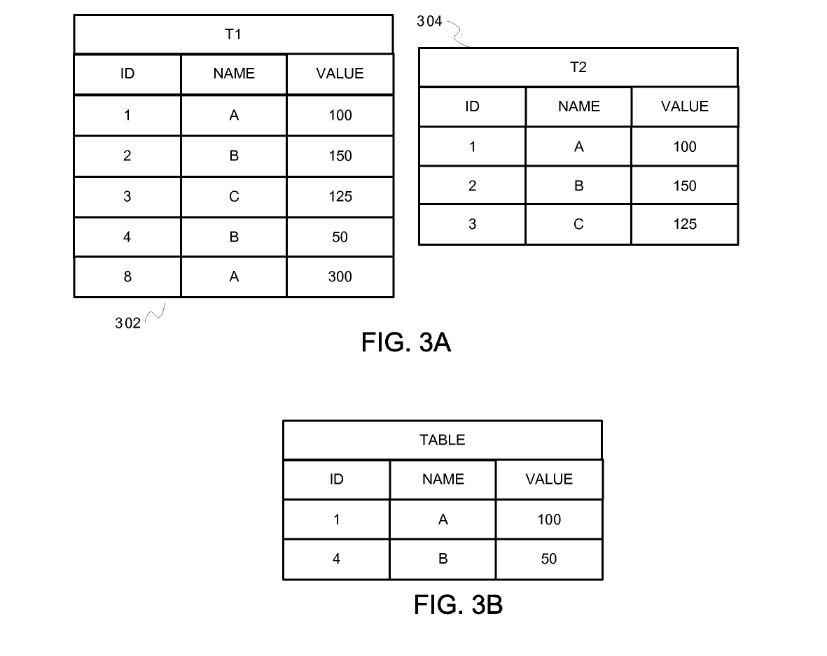

Consider tables T1 (302) and T2 (304), as shown in FIG. 3A. The tables T1 and T2 are consistent with the following SQL table definition:

create table T1
(
id integer not null,
name char(10),
value integer
);
create table T2
(
id integer not null,
name char(10),
value integer
);

The following query, Q1, is used to illustrate an example of Union elimination, according to some embodiments of the inventive subject matter. Q1 reads as follows:

Q1

select * from T1
where value = 50 or not exists (select name from T2)
UNION
select * from T1
where value = 100;

As shown, Query Q1 contains two query blocks as operands of a Union operator. Both query blocks have a common table T1. A query block that is an operand of a Union, Intersect, or Except operator is referred to herein as a branch. Branches are part of Union, Intersect, or Except operations. In the first branch of Q1, B1 is the expression that is representative of the first “where” clause in Q1, where B1 is:
B1: value=50 or not exists (select name from T2).
In the second branch in Q1, B2 is representative of the second “where” clause in Q1, where B2 is:
B2: value=100

Some embodiments eliminate a Union operation for queries having two or more branches sharing a common table. That is, queries are optimized by eliminating the Union operations. In Q1, both branches (B1 and B2) operate on T1. Accordingly, embodiments can transform Q1 into a new query Q2. Q2 is written as follows:

Q2

select *
from T1
where (value = 50 or not exists (Select name from T2)) or
(value = 100);

The local subquery “select name from T2” (from the first branch in Q1) can be evaluated later. The transformation of Q1 to Q2 causes generation of an execution plan that accesses (e.g., full table scan T1 or index based scan of T1) table T1 once to compute Q1 rather than twice in the original branches. The transformation can be expressed as:

(T1) UNION (T1)=T1 WHERE (B1) OR (B2).

When evaluated by a DBMS, Q2 produces the same results as those produced by Q1. FIG. 3B shows the results of evaluating Q1 and Q2. Q2 does not include a UNION operation and does not involve a duplication of the T1 table. Therefore, in Q2, one table has been eliminated from Q1, thereby increasing the efficiency of processing the query Q1.

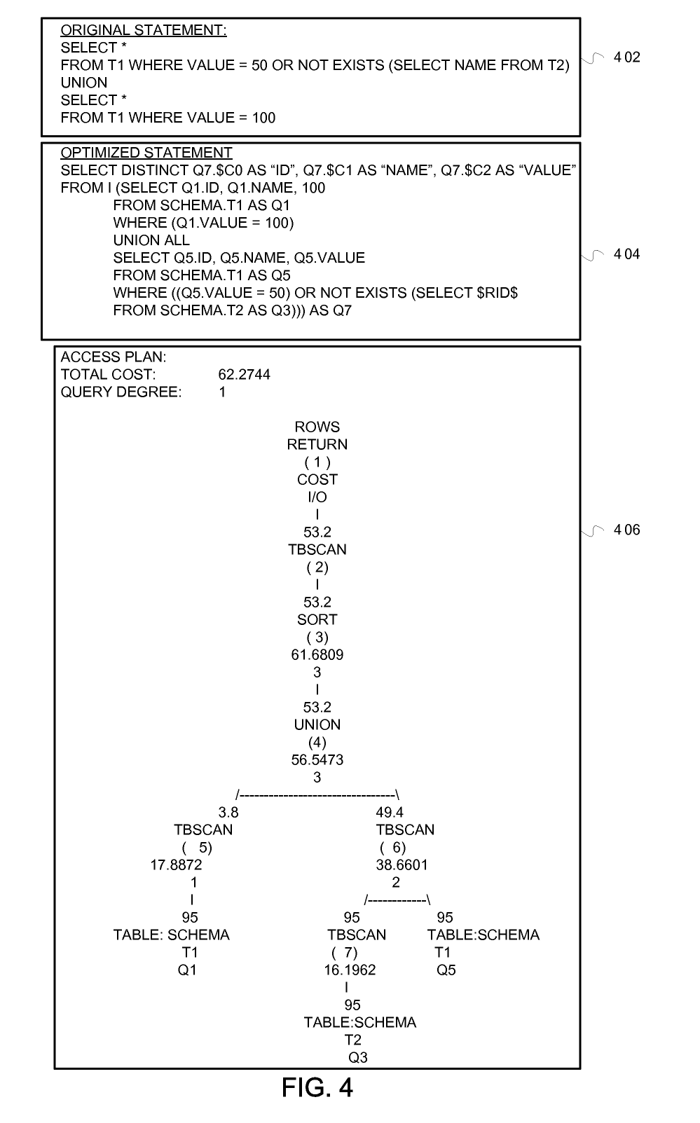

FIG. 4 shows data from a DBMS's optimizer after the optimizer processed Q1. In FIG. 4, a code block 402 shows Q1 before the optimizer runs optimizations on Q1. The code block 404 shows how the optimizer optimizes Q1. The access plan 406 shows performance metrics associated with processing Q1, as determined by the optimizer. The optimizer that produced the code blocks 402 and 404, and the access plan 406 is part of a DB2 DBMS available from International Business Machines, Inc.

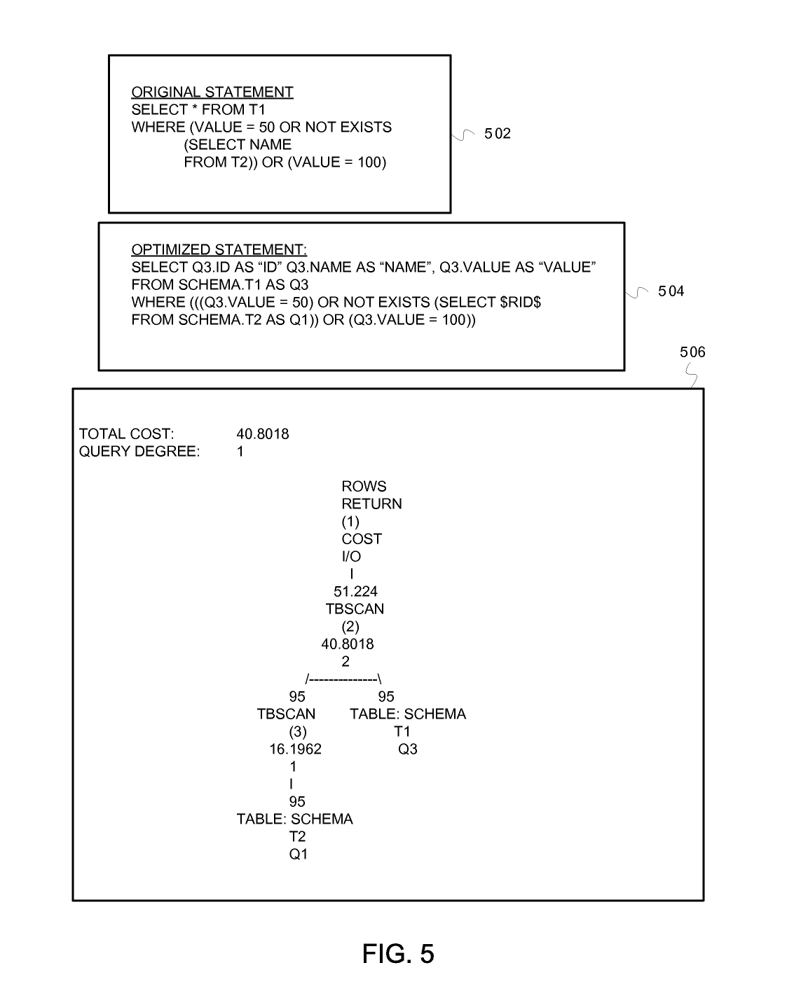

FIG. 5 shows data from a DBMS's optimizer after the optimizer processed Q2. As noted above, Q2 is an optimized version of Q1 that does not include a Union operation. After Q1 is rewritten into Q2, the optimizer further optimizes Q2. In FIG. 4, a code block 502 shows Q2. The code block 504 shows how the optimizer further optimizes Q2. The access plan 506 shows performance metrics associated with processing Q2, as determined by the optimizer. The optimizer that produced the code blocks 402 and 404 (e.g., query optimizer 208) and the access plan 406 is part of a DB2 DBMS available from International Business Machines, Inc.

A comparison between the access plans 406 & 506 reveals that Q2 performs better than Q1. More specifically, the DBMS's TimerOn metric indicates 62.2744 for processing Q1, whereas the TimerOn metric for Q2 is 40.8018. The TimerOn metric gives a rough relative estimate of the resources needed by the DBMS to execute the queries. Therefore, eliminating a query's Union operation according to the inventive methods described here can result in better performance.

This description will proceed with a discussion of how some embodiments can transform queries that include Intersect operators or Intersect All operators.

The following query, Q3, is used to illustrate an example of how some embodiments eliminate Intersect or Intersect All operations from queries, according to some embodiments of the inventive subject matter. Q3 reads as follows:

Q3

select * from T1
where value = 50 or name IN (select name from T2)
intersect
select * from T1
where value = 100;

Query Q3 contains two query blocks as operands of an INTERSECT operator. Both query blocks have a common table T1. Q3 has two branches. The expression by the first “where” clause is a branch—B3. The following statement represents B3.

B3: value=50 or name IN (select name from T2)
The second branch of Q3 is B4. In Q3, the second branch (B4) resides by the second “where” clause. The following statement represents B4.
B4: value=100

Some embodiments can eliminate the Intersect statement. A query with two or more base branches sharing a common table can be transformed so that the common table is optimized to eliminate the Intersect (or Intersect All) statement. Accordingly, some embodiments transform Q3 into Q4 as follows:

Q4:

select * from T1
where (value = 50 or name IN (select name from T2)) and
(value = 100);

The local subquery “select name from T2” from the first branch in Q3 can be pulled up (i.e. evaluated later). The transformation of Q3 to Q4 causes generation of an execution plan that accesses (e.g., full table scan T1 or index based scan of T1) table T1 once to compute Q3 rather than twice in the original base branches. The transformation can be expressed as:

### (T1) INTERSECT/INTERSECT ALL (T1)=T1 WHERE (B3) AND (B4).

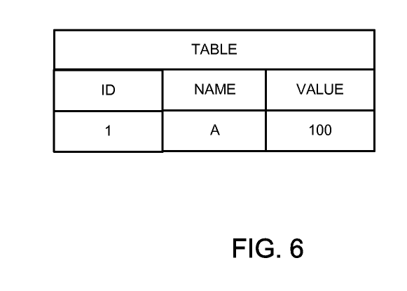

When evaluated by a DBMS, Q4 produces the same results as those produced by Q3. FIG. 6 shows the results produced by evaluating Q4. Q4 does not include an Intersect operation and does not involve a duplication of the T1 table. Therefore, in Q4, one table that was in Q3 has been eliminated, thereby increasing efficiency for processing the query.

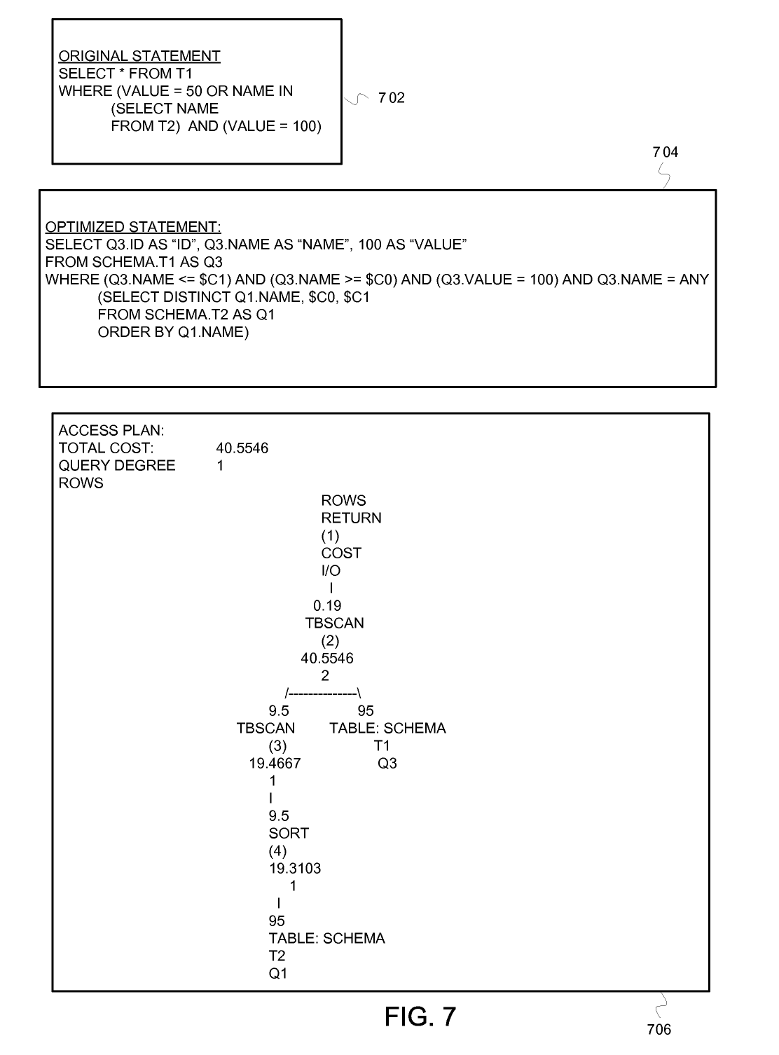

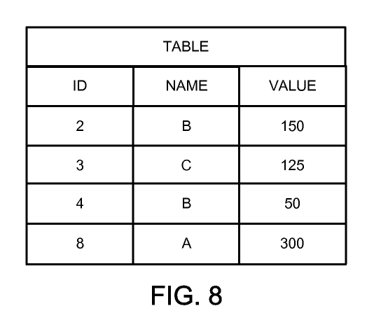

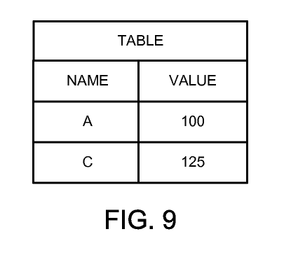

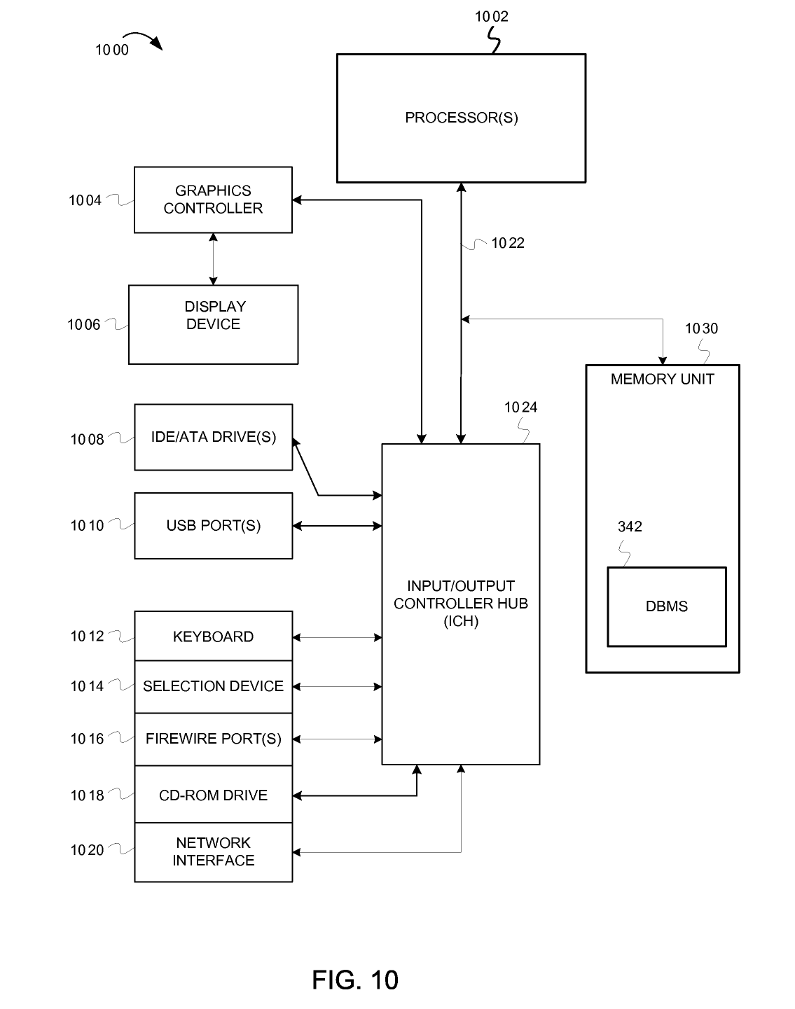

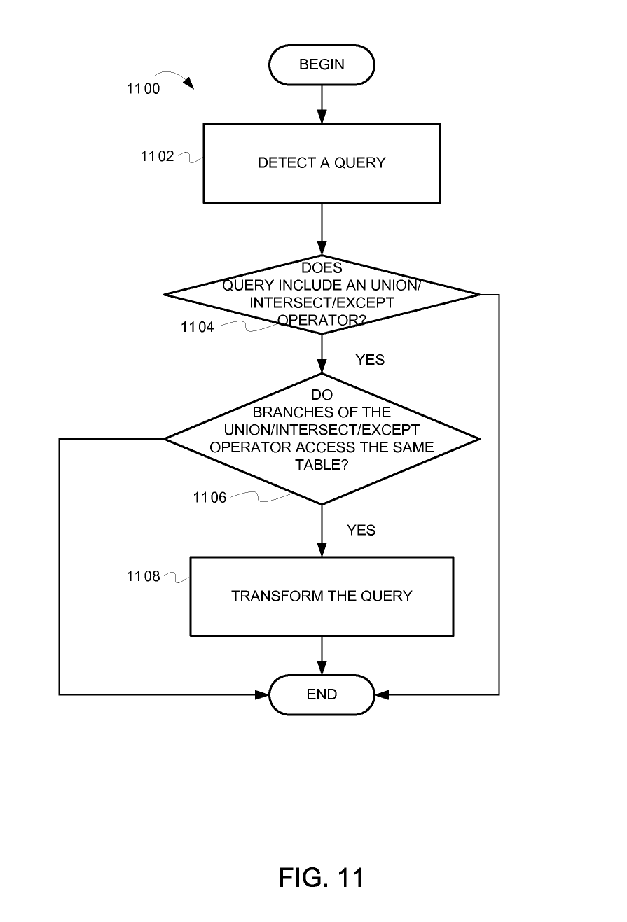

FIG. 7 illustrates how a DB2 optimizer processes Q4. In FIG. 7, after the optimizer transforms Q3 to Q4, there is no Intersect operation in the query (see code block 702). FIG. 7 shows how the optimizer processes Q4 (see code block 704), and the access plan for processing Q4 (see code block 706). In comparison to Q3, the optimizer can process Q4 faster than Q3.

This description will proceed with a discussion of how some embodiments can transform queries that include Except or Except All operators.

The following queries, Q5 and Q6, illustrate how some embodiments eliminate Except or Except All operations. The following represents Q5:

Q5

select * from T1
where value = 50 or name IN (select name from T2)
except
select * from T1
where value = 100;

Query Q5 includes two query blocks as operands of an Except operator. Both query blocks have a common table T1. The first branch of Q5, B5, resides by Q5's first “where” clause. The following represents B5.
B5:value=50 or name IN (select name from T2)
B6 is a second branch in Q5. B6 resides by Q5's second “where” clause. B6 is represented below.
B6: value=100

Some embodiments can eliminate Except or Except All operators from queries. A query having two or more base branches sharing a common table is transformed so that the common table is optimized through elimination of duplicative usage. Accordingly, some embodiments transform Q5 into Q6 as follows:

Q6

select * from T1
where (value = 50 or name IN (select name from T2)) and not
(value = 100);

The local subquery “select name from T2” in the first branch in Q5 can be pulled up (i.e. evaluated later). The transformation of Q5 to Q6 causes generation of an execution plan that accesses (e.g., full table scan T1 or index based scan of T1) table T1 once in Q6 rather than twice in Q5's original base branches. The transformation can be expressed as:

### (T1) EXCEPT/EXCEPT ALL (T1)=T1 WHERE (B5) AND NOT (B6).

The DBMS's evaluation of Q6 produces the same results as those produced by evaluating Q5. Evaluating Q5 and Q6 results in table 802, shown in FIG. 8. As noted above, Q6 does not include an EXCEPT operation and does not involve a duplication of the T1 table. Therefore, one table has been eliminated from Q5, thereby increasing the efficiency of processing the query.

The above-described methods of handling Union, Intersect, and Except operators can be combined together to handle more complicated queries. Consider the following query, Q7, as an example. Q7 is represented as follows:

Q7

select t1.name, t1.value from T1 as t1, T2 as t2
where t1.id = t2.id and t1.value = 50 or t1.name = ‘A’
intersect
select name, value from T1
where value = 100
union
select name, value from T1
where value = 125;

Q7 is a query with an additional join on the first branch. Some embodiments transform Q7 into Q8. Q8 is represented as follows:

Q8

select t1.name, t1.value from T1 as t1, T2 as t2
where t1.id = t2.id and (t1.value = 50 or t1.name = ‘A’ AND
t1.value = 100 OR t1.value = 125);

Evaluation of Q7 and Q8 produces the same table, as shown in FIG. 9. Because Q8 does not include Intersect and Union operations, the DBMS can process Q8 faster than Q7.

### More Example System Components

FIG. 10 depicts an example computer system, according to. A computer system includes a processor unit 1001 (possibly including multiple processors, multiple cores, multiple nodes, and/or implementing multi-threading, etc.). The computer system includes memory 1007. The memory 1007 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media.

The computer system also includes a bus 1003 (e.g., PCI, ISA, PCI-Express, HyperTransport®, InfiniBand®, NuBus, etc.), a network interface 1005 (e.g., an ATM interface, an Ethernet interface, a Frame Relay interface, SONET interface, wireless interface, etc.), and a storage device(s) 1009 (e.g., optical storage, magnetic storage, etc.). The system memory 1007 embodies functionality to implement embodiments described above. For example, the system memory 1007 include DBMS 342, which can transform database queries, as described above. For example, in some instances, the DBMS 342 eliminates Union, Intersect, Intersect All, Except, and/or Except All operations from queries, as described above. In some embodiments, the DBMS 342 includes components similar to those shown in FIG. 2. The DBMS 342 can include code that executes on the processing unit 1001 and other components of the computer system. In some instances, the DBMS 342 does not reside entirely in the memory 1007. For example, the DBMS 342 may be implemented with an application specific integrated circuit, in logic implemented in the processing unit 1001, in a co-processor on a peripheral device or card, etc. Further, realizations may include fewer or additional components not illustrated in FIG. 10 (e.g., video cards, audio cards, additional network interfaces, peripheral devices, etc.). The processor unit 1001, the storage device(s) 1009, and the network interface 1005 are coupled to the bus 1003. Although illustrated as being coupled to the bus 1003, the memory 1007 may be coupled to the processor unit 1001.

While the embodiments are described with reference to various implementations and exploitations, it will be understood that these embodiments are illustrative and that the scope of the inventive subject matter is not limited to them. In general, techniques for processing database queries, as described herein, may be implemented with facilities consistent with any hardware system or hardware systems. Many variations, modifications, additions, and improvements are possible.

### Additional Operations

This section will discuss additional operations for processing database queries, according to some embodiments of the inventive subject matter.

FIG. 11 is a flow diagram illustrating operations for transforming database queries, according to some embodiments of the inventive subject matter. In FIG. 11, a flow 1100 begins at block 1102, where a DBMS's query optimization unit detects a database query. In some embodiments, the database query is formatted as a SQL query. The flow continues at block 1104.

At block 1104, the query optimizer determines whether the query includes a Union, Intersect, or Except operator. For example, if the optimizer receives Q1 (see above), the query optimizer would recognize that the query includes a Union operator. As such, the flow would continue at block 1106. If the query optimizer received a query that does not include a Union, Intersect, or Except operator, the flow ends.

At block 1106, the query optimizer determines whether branches of the Union, Intersect, or Except operator access the same table. For example, when processing Q1, the query optimizer determines that both branches of the Union operator access T1. If both branches access the same table, the flow continues at block 1108. Otherwise, the flow ends.

At block 1108, the query optimizer transforms the query. For example, the query optimizer can transform queries to eliminate Union, Intersect, and/or Except operators. As described above vis-á-vis Q1, the query optimizer can transform Q1 into Q2 according to the following formulas:

As noted above, embodiments of the inventive subject matter can perform query transformations according to other formulas. For example, some embodiments employ the following formulas for query transformation:

### (T1) UNION (T1)=T1 WHERE (B1) OR (B2)

### (T1) INTERSECT/INTERSECT ALL (T1)=T1 WHERE (B3) AND (B4)

### (T1) EXCEPT/EXCEPT ALL (T1)=T1 WHERE (B5) AND NOT (B6)

As shown above, the query optimizer can also transform queries including Intersect All and Except All operators.

As will be appreciated by one skilled in the art, aspects of the present inventive subject matter may be embodied as a system, method or computer program product. Accordingly, aspects of the present inventive subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. The program code can include instructions to perform any of the operations described herein, such as operations for transforming database queries, as described above.

Computer program code for carrying out operations for aspects of the present inventive subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventive subject matter are described with reference to flowchart illustrations and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method for transforming queries in a database management system, the method comprising:
detecting a first query, wherein the first query produces a first result upon evaluation by the database management system;
determining that the first query includes at least one operator, wherein the operator is selected from a union operator, an intersect operator, and an except operator, and wherein the operator has a first branch and second branch;
determining that the first branch of the operator accesses a first table, and wherein the second branch of the union operator also accesses the first table;
transforming the first query into a second query, wherein the second query does not include the operator, and wherein the second query produces the first result upon evaluation by the database management system.

2. The method of claim 1, wherein the operator is further selected from an Intersect All operator and an Except All operator.

3. The method of claim 1, wherein the query is formatted according to the Structured Query Language.

4. The method of claim 1, wherein the transforming the first query into the second query includes adding one or more of an OR operator and an And operator to the query.

5. The method of claim 1 wherein the first branch is a first query block that is an operand of the operator, and wherein the second brand is a second query block that is an operand of the operator.

6. The method of claim 1, wherein evaluation of the second query is faster than evaluation of the first query.

7. A computer program product for transforming queries in a database management system, the computer program product comprising:
a computer readable storage medium having computer usable program code embodied therewith, the computer usable program code comprising a computer usable program code configured to:
detect a first query, wherein the first query produces a first result upon evaluation by the database management system;
determine that the query includes at least one operator, wherein the operator is selected from a union operator, an intersect operator, and an except operator, and wherein the operator is associated with a first branch and second branch;
determine that the first branch of the operator accesses a first table, and wherein the second branch of the union operator also accesses the first table;
transform the first query into a second query, wherein the second query does not include the operator, and wherein the second query produces the first result upon evaluation by the database management system.

8. The computer program product of claim 7, wherein the operator is further selected from an Intersect All operator and an Except All operator.

9. The computer program product of claim 7, wherein the query is formatted according to the Structured Query Language.

10. The computer program product of claim 7, wherein the program code to transform the first query into the second query includes program code to add one or more of an OR operator and an And operator to the query.

11. The computer program product of claim 7, wherein the first branch is a first query block that is an operand of the operator, and wherein the second brand is a second query block that is an operand of the operator.

12. The computer program product of claim 7, wherein the database management system can evaluation of the second query is faster than evaluation of the first query.

13. An apparatus comprising:
a processor configured to execute instructions for a a database management system;
the database management system configured to process database queries, wherein the database management system includes
a query transformation unit configured to
detect a first query, wherein the first query produces a first result upon evaluation by the database management system;
determine that the query includes at least one operator, wherein the operator is selected from a union operator, an intersect operator, and an except operator, and wherein the operator is associated with a first branch and second branch;
determine that the first branch associated with the operator accesses a first table, and wherein the second branch associated with the union operator also accesses the first table;
transform the first query into a second query, wherein the second query does not include the operator, and wherein the second query produces the first result upon evaluation by the database management system.

14. The apparatus of claim 13, wherein the operator is further selected from an Intersect All operator and an Except All operator.

15. The apparatus of claim 13, wherein the query is formatted according to the Structured Query Language.

16. The apparatus of claim 13, wherein the program code to transform the first query into the second query includes program code to add one or more of an OR operator and an And operator to the query.

17. The apparatus of claim 13, wherein the first branch is a first query block that is an operand of the operator, and wherein the second brand is a second query block that is an operand of the operator.

18. The apparatus of claim 13, wherein the database management system can evaluation of the second query is faster than evaluation of the first query.

19. A computer program product for transforming queries in a database management system, the computer program product comprising:
a computer readable storage medium having computer usable program code embodied therewith, the computer usable program code comprising a computer usable program code configured to:
detect a first structured query language (SQL) query, wherein the first SQL query produces a first result;
determine that the first SQL query includes a union operator wherein the union operator includes a first branch and second branch, wherein the first and second branches are operands for the union operator;
determine that the first branch of the union operator accesses a first table, and wherein the second branch of the union operator also accesses the first table;
transform the first SQL query into a second SQL query, wherein the second SQL query does not include the union operator, and wherein the second SQL query produces the first result.

20. The computer program product of claim 19, wherein the second SQL query includes an OR operator.

21. The computer program product of claim 19, wherein the program code to transform the first SQL query into the second SQL query includes program code to add one or more of an AND operator and an OR operator to the first SQL query.

22. The computer program product of claim 19, wherein the second SQL query includes less SQL code than the first SQL query.

23. The computer program product of claim 19, wherein the database management system can evaluate the second SQL query faster than first SQL query.

24. The computer program product of claim 19, wherein the second SQL query requires less computing resources than the first SQL query.

25. The computer program product of claim 19, wherein the first and second branches include SQL sub-queries to be evaluated by the database management system.
